(19) United States
(12) Patent Application Publication
(10) Pub. No.: US 2007/0175481 A1
(43) Pub. Date: Aug. 2, 2007

(54) Device for supporting insertion of medical instrument into human body

(75) Inventors: Isamu Koyama, Saitama (JP); Shuro Hayashi, Hiroshima (JP)

Correspondence Address: NIXON PEABODY, LLP, 401 9TH STREET, NW, SUITE 900, WASHINGTON, DC, 20004-2128, US

(73) Assignee: JMS CO., Ltd., Hiroshima (JP)

(21) Appl. No.: 10/594,720

(22) PCT Filed: Mar. 31, 2005
(86) PCT No.: PCT/JP05/06348

§ 371 Date: Sep. 29, 2006

(30) Foreign Application Priority Data
Apr. 2, 2004 (JP) 2004-109926
Mar. 28, 2005 (JP) 2005-092013

(51) Int. Cl. A62B 9/06

(52) U.S. Cl. 128/207.14

(57) ABSTRACT

A tubular member 2 is formed of a resin material so as to have an inner passageway 2. A thin plate is shaped into a spiral along the perimeter of the tubular member 2 to form a reinforcement member 3. The reinforcement member 3 is buried in a peripheral wall 2a of the tubular member 2. The tubular member 2 and the reinforcement member 3 have curved shapes conformable to the shape of the pharynx 100. The tubular member 2 and the reinforcement member 3 are inserted from the oral cavity 102 into the pharynx 100 and retained there. A medical instrument is guided to the esophagus 103 through an inner passageway 2b of the tubular member 2.

### TECHNICAL FIELD

The present invention relates to a device for supporting insertion of a medical instrument into a human body, which is used for, for example, inserting a medical instrument, such as an endoscope, or the like, into a digestive organ from the oral cavity through the pharynx.

### BACKGROUND ART

Conventionally, for example, in diagnosis and treatment of digestive organs, such as stomach, esophagus, etc., the manipulation of inserting a medical instrument, such as an endoscope, or the like, into a digestive organ of a patient from the oral cavity through the pharynx has been carried out. The manipulation of inserting the medical instrument into the digestive organ is difficult because the pharynx, which extends between the oral cavity and the esophagus, has a curved shape. A manipulation of repeatedly inserting and pulling out the medical instrument entails an increased number of times the medical instrument passes through the pharynx, which imposes a larger load on the patient. In view of such circumstances, for example, as disclosed in Patent Document 1, a tubular supporting device is inserted from the oral cavity through the pharynx up to the entrance of the esophagus and retained there, and the inner passageway of this supporting device is used to insert the medical instrument into and pull the medical instrument out of a digestive organ, whereby the manipulation of inserting the medical instrument is made easier, and the load on the patient is reduced.

The supporting device of Patent Document 1 is formed by a tubular member of a resin material and a reinforcement member of a spiral thin elastic wire which is buried in the tubular member. When inserted into the pharynx, this supporting member can support the inner wall of the pharynx with the wire of the reinforcement member such that the pharynx is prevented from narrowing.

Patent Document 1: Japanese Laid-Open Patent Publication No. 7-51221 (Page 3, FIG. 1, FIG. 4).

### DISCLOSURE OF INVENTION

### Problems to be Solved by the Invention

In recent years, the demand has been increasing that, in the diagnosis and treatment of a digestive organ, a medical instrument is inserted from the oral cavity to a digestive organ while the number and size of laparotomies and thoracotomies are decreased as small as possible or eliminated such that the load on patients is decreased. In this case, it is desirable to secure a large space for inserting the medical instrument(s) by increasing the diameter of the tubular member of Patent Document 1 because a plurality of medical instruments, including for example an endoscope for an operator to observe a subject region and an ablation tool for an affected area, are sometimes simultaneously inserted from the oral cavity, or a medical instrument having a relatively large diameter which has both the function of ablating the affected area and the endoscope function is sometimes inserted.

However, since the inner diameter of the pharynx of a patient is limited, there is a possibility that a large diameter of the tubular member makes it difficult for an operator to insert the tubular member and largely expands the pharynx of the patient, so that the load on the patient can be increased.

The present invention was conceived in view of the above circumstances. An objective of the present invention is to guide a medical instrument into a digestive organ using a tubular member inserted from the oral cavity into the pharynx and retained there while a large insertion space is secured for the medical instrument, the workability of inserting the tubular member into the pharynx is improved, and the load on the patient is reduced.

### Means for Solving the Problems

To achieve the above objective, according to the first invention of the present application, the reinforcement member is formed of a thin plate, and the reinforcement member and the tubular member are curved so as to be conformable to the curvature of the pharynx.

Specifically, the supporting device includes: a tubular member having an inner passageway between its opposite ends through which the medical instrument is capable of passing; and a reinforcement member formed by a thin plate extending along a perimeter of the inner passageway, wherein the tubular member and the reinforcement element have curved shapes conformable to the shape of a pharynx of a human body and, when inserted from an oral cavity into the pharynx and retained there, guide the medical instrument to a digestive organ through the inner passageway.

With this structure, the tubular member and the reinforcement member are curved according to the curvature of the pharynx. Therefore, the tubular member and the reinforcement member can be smoothly inserted into the pharynx without any substantial deformation. Thus, small force is necessary for insertion of the tubular member into the pharynx, and accordingly, the load on a patient is decreased.

Since the reinforcement member is formed by a thin plate extending along the perimeter of the inner passageway, the dimension of the reinforcement member in the thickness direction of the peripheral wall, i.e., the thickness of the thin plate, is set smaller than the wire diameter when the conventional reinforcement member is formed by a wire, so that the thickness of the peripheral wall is decreased, while the width of the thin plate is set greater than the wire diameter of the conventional wire, whereby sufficient strength of the reinforcement member can be obtained. Thus, flattening deformation of the tubular member can be suppressed while the thickness of the peripheral wall of the tubular member is decreased such that a sufficient insertion space is secured for the medical instrument.

In the second invention, a guiding member having a smaller diameter than a tubular member is inserted into the pharynx, and the tubular member can be guided to the pharynx through the guiding member.

Specifically, the supporting device includes: a tubular member having an inner passageway between its opposite ends through which the medical instrument is capable of passing; a reinforcement member extending along a perimeter of the inner passageway; and a guiding member having a diameter smaller than the inner passageway and insertable from an oral cavity of a human body into a pharynx, the guiding member guiding, when inserted into the pharynx, the tubular member and the reinforcement member from the oral cavity to the pharynx, wherein, when guided to the pharynx and retained there, the tubular member and the reinforcement member guide the medical instrument to a digestive organ through the inner passageway.

With this structure, after the guiding member is inserted from the oral cavity to the pharynx and retained there, the oral cavity end of the guiding member is inserted into the inner passageway of the tubular member, and then, the tubular member and the reinforcement member can be inserted into the pharynx along the guiding member. Specifically, the guiding member, which has a smaller diameter than the tubular member, is first inserted so that, firstly, the inside diameter of the pharynx is expanded by the guiding member, and thereafter, the inside diameter of the pharynx can be further expanded by the tubular member having a larger diameter. Such gradual expansion of the inside diameter of the pharynx can reduce the load on a human body in the process of securing a large insertion space for the medical instrument by inserting a large-diameter medical instrument into the pharynx. Further, the guiding member has a smaller diameter than the tubular member and is therefore readily inserted into the pharynx. With this guiding member, the tubular member and the reinforcement member can readily be inserted into the pharynx.

According to the third invention, in the first invention, a guiding member having a diameter smaller than the inner passageway of the tubular member and insertable from the oral cavity into the pharynx is provided. When inserted into the pharynx, the guiding member guides the tubular member and the reinforcement member from the oral cavity to the pharynx.

With this structure, the tubular member and the reinforcement member can readily be inserted into the pharynx along the guiding member as in the second invention.

According to the fourth invention, in any one of the first to third inventions, the reinforcement member has the shape of a spiral continuously extending in a center line direction of the inner passageway.

With this structure, the tubular member is continuously reinforced in the center line direction.

According to the fifth invention, in any one of the first to fourth inventions, a digestive organ end of the tubular member extends toward a digestive organ ahead of a digestive organ end of the reinforcement member.

With this structure, the end of the tubular member is closer to the digestive organ than the end of the reinforcement member is. Therefore, when inserting the tubular member and the reinforcement member into the pharynx, the reinforcement member can be prevented from coming in contact with organic tissue.

According to the sixth invention, in any one of the first to fifth inventions, the digestive organ end of the tubular member is slanted with respect to the center line of the inner passageway.

With this structure, the digestive organ end of the tubular member has a tapered shape. Therefore, the operation of inserting the tubular member into the pharynx becomes still easier.

According to the seventh invention, in any one of the first to sixth inventions, the tubular member is molded with the reinforcement member buried therein.

According to this invention, in the process of molding the tubular member, the tubular member and the reinforcement member can be integrated.

According to the eighth invention, in any one of the second to seventh inventions, the guiding member includes a guiding member engagement section; and the tubular member includes a tubular member engagement section for engaging with the guiding member engagement section of the guiding member inserted up to a predetermined position in the inner passageway of the tubular member.

According to this invention, when inserting the tubular member into the pharynx along the guiding member, the guiding member engagement section is engaged with the tubular member engagement section, so that the tubular member becomes immovable with respect to the guiding member. The guiding member has a smaller diameter than the tubular member and therefore can readily be inserted into the pharynx. Thus, the guiding member can be inserted to a correct position in the pharynx. The positions of the engagement sections are set such that, when the tubular member is inserted to a correct position in the pharynx with respect to the guiding member as a reference, the guiding member engagement section engages with the tubular member engagement section. With such setting, the operator can readily insert the tubular member to the correct position.

According to the ninth invention, in any one of the second to seventh inventions, the guiding member has a guiding member alignment mark; and the tubular member has a tubular member alignment mark aligned with the guiding member alignment mark of the guiding member inserted to a predetermined position in the inner passageway of the tubular member.

With this structure, the guiding member can be inserted to a correct position in the pharynx as in the eighth invention. The positions of the alignment marks are set such that, when the tubular member is inserted to a correct position in the pharynx with respect to the guiding member as a reference, the guiding member alignment mark engages with the tubular member alignment mark. With such setting, the operator can readily insert the tubular member to the correct position.

According to the tenth invention, in any one of the first to ninth inventions, the tubular member is made of a resin material; and the guiding member is made of another resin material harder than the resin material of the tubular member.

With this invention, flattening deformation of the guiding member inserted into the pharynx is decreased such that the pharynx can be effectively expanded. Since the tubular member, which has a larger diameter than the guiding member, is made of a resin material softer than the resin material of the guiding member, the load on a human body can be further reduced.

### EFFECTS OF THE INVENTION

According to the first invention, the reinforcement member is formed by a thin plate extending along the perimeter of the inner passageway of the tubular member. Thus, the peripheral wall of the tubular member can be made thin so that a large insertion space is secured for the medical instrument. Further, the tubular member and the reinforcement member are curved so as to be conformable to the shape of the pharynx. Therefore, the workability of insertion of the tubular member into the pharynx is improved, while the load on a human body can be suppressed.

According to the second invention, the tubular member is guided to the pharynx using the guiding member which has a smaller diameter than the tubular member. Therefore, a large insertion space can be secured for the medical instrument by inserting the tubular member having a larger diameter into the pharynx while the load on a human body is suppressed. Further, the workability of insertion of the tubular member into the pharynx is improved.

According to the third invention, the supporting device has a guiding member which has a smaller diameter than the inner passageway of the tubular member. Therefore, the workability of insertion of the tubular member and the reinforcement member into the pharynx is further improved.

According to the fourth invention, the reinforcement member has a spiral shape. Therefore, the tubular member can be continuously reinforced in the center line direction.

According to the fifth invention, the digestive organ end of the tubular member is closer to the digestive organ than the reinforcement member is. Load caused on a human body when the tubular member and the reinforcement member are inserted into the pharynx can be decreased.

According to the sixth invention, the digestive organ end of the tubular member can be tapered. Therefore, the workability of insertion of the tubular member into the pharynx is further improved.

According to the seventh invention, the tubular member and the reinforcement member can be integrated in the molding of the tubular member. Therefore, the production process can be simplified.

According to the eighth invention, when inserting the tubular member into the pharynx along the guiding member, an operator can readily insert the tubular member to a correct position.

According to the ninth invention, the tubular member can readily be inserted to a correct position as in the eighth invention.

According to the tenth invention, the pharynx can be effectively expanded by the guiding member, and the load caused on a human body when the tubular member is inserted into the pharynx can be further decreased.

### BRIEF DESCRIPTION OF DRAWINGS

FIG. 1 is a cross-sectional view of a supporting device according to embodiment 1 of the present invention.

FIG. 2 is a side view of a tubular member according to embodiment 1.

FIG. 3 is a cross-sectional view of a tubular member according to embodiment 1.

FIG. 4 shows a tubular member retained in the larynx of a patient lying face up.

FIG. 5 is a perspective view of a reinforcement member according to embodiment 1.

FIG. 6 is a cross-sectional view of a first guiding member and second guiding member according to embodiment 1.

FIG. 7 is a side view of an anastomosis device.

FIG. 8(a) shows a main body of a device seen from the head side. FIG. 8(b) shows a head seen from the main body side.

FIG. 9 shows the anastomosis device with the main body inserted in the esophagus and the head inserted in the small intestine.

FIG. 10 shows an end of the esophagus anastomosed to an end of the small intestine.

FIG. 11 illustrates insertion of the main body of the anastomosis device into the esophagus using the tubular member.

FIG. 12 illustrates ablation of a stricture in the esophagus using the anastomosis device.

FIG. 13 illustrates ablation of a tumor from the stomach using an ablation instrument.

FIG. 14 shows that an endoscope, which is integrated with an ablation blade, is inserted in the stomach.

FIG. 15 illustrates ablation of early-stage stomach cancer using an ablation instrument.

FIG. 16 illustrates installation of a stent in the esophagus.

FIG. 17 is a cross-sectional view according to embodiment 2 of the present invention, which is equivalent to FIG. 1.

FIG. 18 is a side view of a supporting device according to embodiment 2 with alignment marks being coincident with each other.

FIG. 19 is a side view of a supporting device according to a variation of embodiment 2.

### DESCRIPTION OF REFERENCE NUMERALS

1 Supporting Device
2 Tubular Member
2b Inner passageway
2c Cavity (Tubular Member Engagement Section)
3 Reinforcement Member
4 First Guiding Member
4b Protrusion (Guiding Member Engagement Section)
5 Second Guiding Member
21 Main Body of Device (Medical Instrument)
100 Pharynx
102 Oral Cavity
103 Esophagus (Digestive Organ)
130 Tubular Member Alignment Mark
131, 132 First Guiding Member Alignment Mark
133 Second Guiding Member Alignment Mark
140 Cavity (Tubular Member Engagement Section)
141 Protrusion (Guiding Member Engagement Section)

### BEST MODE FOR CARRYING OUT THE INVENTION

Hereinafter, embodiments of the present invention will be described in detail with reference to the drawings.

### Embodiment 1

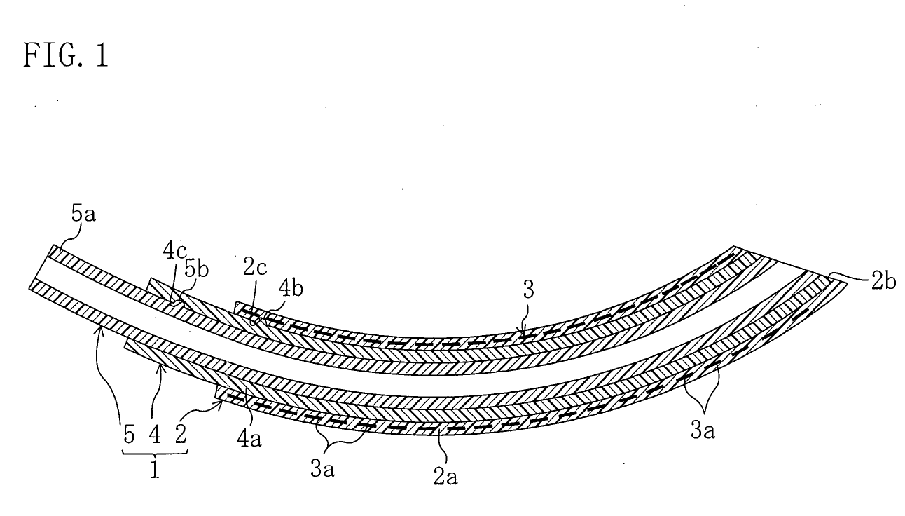

FIG. 1 is a cross-sectional view of a supporting device 1 according to embodiment 1 of the present invention for supporting insertion of a medical instrument into a human body. The supporting device 1 is to be used in inspection, diagnosis or treatment of a digestive organ, such as a human stomach, esophagus, small intestine, or the like, such that the supporting device 1 is inserted into the pharynx and retained there for insertion of the medical instrument from the oral cavity into the digestive organ.

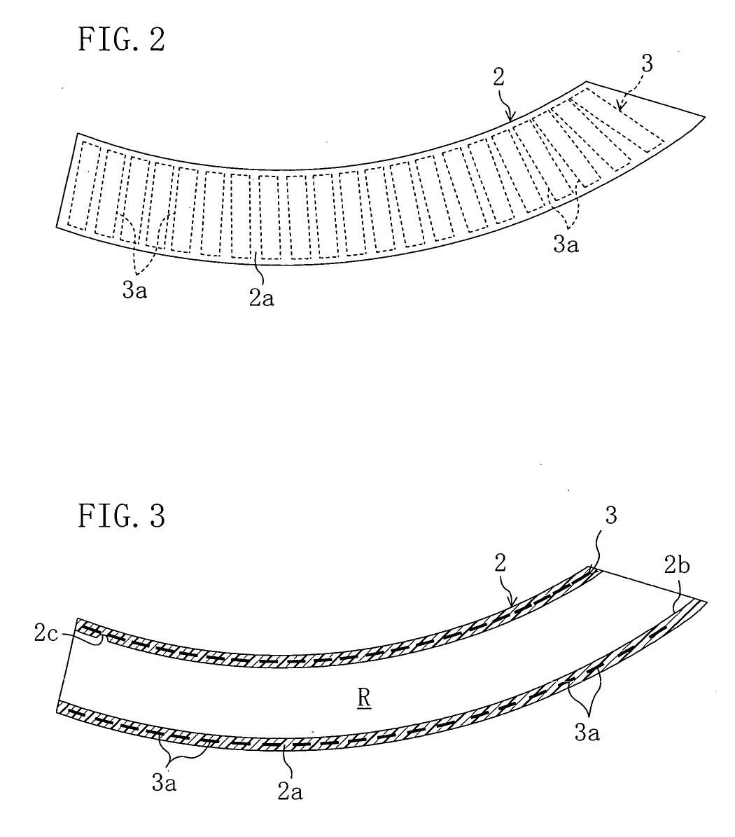

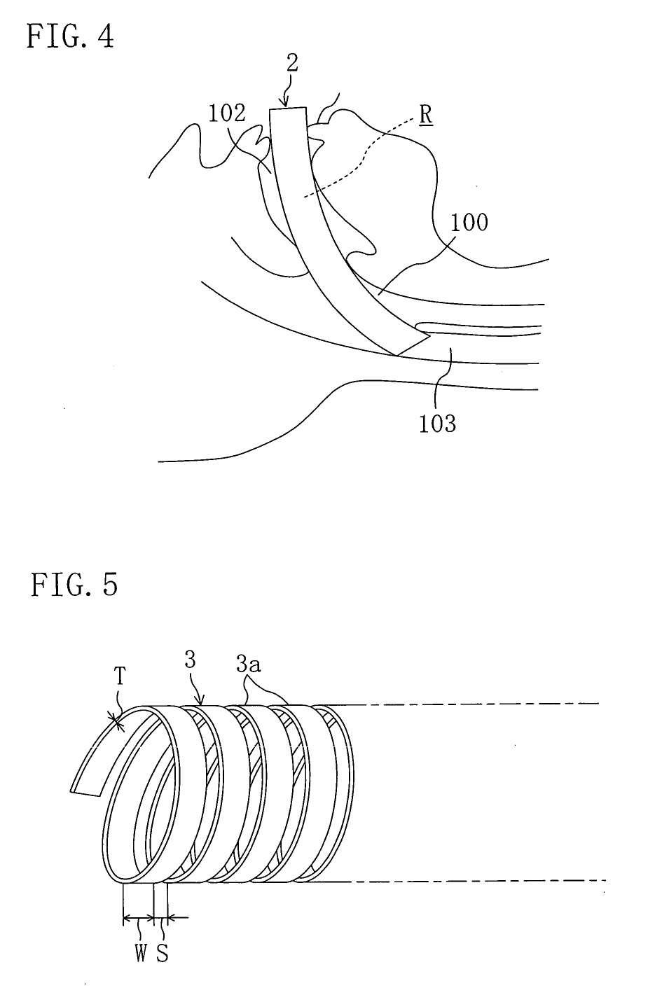

The supporting device 1 includes a tubular member 2 made of a resin, a reinforcement member 3 of a metal which is buried in a peripheral wall 2a of the tubular member 2, and a first guiding member 4 and second guiding member 5 which are inserted in the tubular member 2. The tubular member 2 is formed by pouring melted polyvinyl chloride, or the like, into a mold (not shown) and solidifying the polyvinyl chloride into a cylindrical shape. As shown in FIG. 2, FIG. 3 and FIG. 4, the tubular member 2 has a curved shape conformable to the shape of the pharynx 100 when a human lies face up. The resin material of the tubular member 2 may be polyurethane or rubber resin.

The length of the tubular member 2 between an end closer to the oral cavity (“oral cavity end”) and the other end closer to the digestive organ (“digestive organ end”) is such that, for example, the oral cavity end extends from the anterior teeth to the outside of the oral cavity 102, and the digestive organ end passes through the pharynx 100 and reaches a vicinity of the entrance of the esophagus 103. Specifically, the length of the tubular member 2 along its center line is set between 100 mm and 300 mm.

As shown in FIG. 3, the inner passageway 2b of the tubular member 2 extends between the both ends of the tubular member 2 and opens at the both ends. The medical instrument is to be inserted through the inner passageway 2b. The oral cavity end of the tubular member 2 is formed to extend in a direction generally perpendicular to the center line of the tubular member 2, while the digestive organ end of the tubular member 2 is formed to have an inclination angle between 40° to 70° with respect to a direction in which the center line of the tubular member 2 extends. Thus, the digestive organ end of the tubular member 2 has a tapered shape.

The thickness of the peripheral wall 2a of the tubular member 2 is set, for example, between 2 mm and 4 mm. The thickness of the peripheral wall 2a is changed according to the thickness of a thin plate (described later) which forms the reinforcement member 3, the thickness of a resin material covering the thin plate, or the like. The inside diameter of the tubular member 2 is set between 20 mm and 30 mm. The inside diameter and longitudinal length of the tubular member 2 can be changed according to the type and size of a medical instrument which is inserted into a digestive organ using the supporting device 1, the constitution, age, or sex of a patient, etc.

The outer and inner surfaces of the tubular member 2 are formed by smooth surfaces. The outer and inner surfaces of the tubular member 2 are coated with a frictional-drag reducer. With such surfaces, the outer surface of the tubular member 2 is prevented from being caught in organic tissue when the supporting device 1 is inserted into the pharynx 100. The medical instrument is also prevented from being caught in the inner surface of the tubular member 2 when the medical instrument is inserted into the inner passageway 2b. The outer and inner surfaces of the tubular member 2 can be coated by applying a frictional-drag reducing agent, such as Xylocaine jelly, or the like.

As shown in FIG. 1, the inner surface of the tubular member 2 on the oral cavity side has a cavity 2c, while the outer surface of the first guiding member 4 on the oral cavity side has a protrusion 4b which is fittingly engageable with the cavity 2c. The protrusion 4b exists at such a position that, when the protrusion 4b is engaged with the cavity 2c, the digestive organ end of the first guiding member 4 is generally coincident with the digestive organ end of the tubular member 2.

As shown in FIG. 5, the reinforcement member 3 is formed by a long thin plate. The reinforcement member 3 is a continuous spiral along the center line of the tubular member 2, including circular parts 3a which extend in the peripheral direction of the inner passageway 2b of the tubular member 2. The length of the reinforcement member 3 along the center line is set smaller than the length of the tubular member 2 along the center line. The reinforcement member 3 is provided at an intermediate position of the tubular member 2 when located along the center line direction. Therefore, as shown in FIG. 2 and FIG. 3, the oral cavity end of the tubular member 2 is closer to the oral cavity than the oral cavity end of the reinforcement member 3 is, and the digestive organ end of the tubular member 2 is closer to the digestive organ than the digestive organ end of the reinforcement member 3 is. Since the reinforcement member 3 has a spiral shape as described above, intermediate part of the tubular member 2 in the center line direction is continuously reinforced.

The thin plate is not limited to any particular material so long as it is elastic and has such strength that flattening deformation of the tubular member 2 can be suppressed. For example, the thin plate can be made of a metal material, such as, for example, stainless steel, etc., or a rigid resin material, such as polyamide, fluoric resin, etc. Referring to FIG. 5, the width of the thin plate, W, is set between 1.50 mm and 5.50 mm, and the thickness of the thin plate, T, is set between 0.03 mm and 1.00 mm. In this embodiment, the thin plate is made of SUS304 where width W is about 4.00 mm and thickness T is about 0.20 mm. Making the thin plate thinner enables the thickness of the peripheral wall 2a of the tubular member 2 to be thinner but decreases the strength of the tubular member 2 against force applied in a flattening direction. In view of such, the thickness of the thin plate is preferably set between 0.05 mm and 0.50 mm. Making width W of the thin plate wider increases the strength of the tubular member 2 against force applied in a flattening direction. However, when the tubular member 2 is bent, a portion of the tubular member 2 in which the thin plate exists does not bend but keeps its linear shape. As a result, the tubular member 2 lacks smoothness in curvature, and insertion of an instrument into the pharynx 100 can be difficult. Therefore, width W of the thin plate is preferably set between 2.00 mm and 5.00 mm in consideration of the resistance to flattening deformation and the workability of insertion into the pharynx 100.

Separation S between adjacent circular parts 3a of the reinforcement member 3 is set to about 1.00 mm. Separation S between adjacent circular parts 3a varies because of errors occurring in the production of the reinforcement member 3, positional displacement of the circular parts 3a which is caused by a melted resin material flowing in a cavity of a mold, etc. Thus, separation S is between 0.50 mm and 1.50 mm in the product specifications. Making separation S between adjacent circular parts 3a shorter results in a denser arrangement of circular parts 3a, which increases the strength of the tubular member 2 against force applied in a flattening direction, but results in a reduced amount of resin material dwelling between circular parts 3a, so that it becomes difficult to deform the tubular member 2 in a curve. On the other hand, making separation S between adjacent circular parts 3a longer results in a sparse arrangement of circular parts 3a which decreases the strength of the tubular member 2 against force applied in a flattening direction. In view of such circumstances, separation S between circular parts 3a is set within the above-described range.

Integration of the reinforcement member 3 having the above-described structure with the tubular member 2 is now described. First, the reinforcement member 3 is prepared in advance. Then, the reinforcement member 3 is retained in a cavity of a mold for molding the tubular member 2. At this step, the reinforcement member 3 is deformed to have a curved shape conformable to the shape of the pharynx 100 as described above. Thereafter, melted resin material is poured in the cavity. The melted resin material flows so as to cover the outer and inner surfaces of the reinforcement member 3 and flows into a space between adjacent circular parts 3a. The resin is then solidified. Thus, the reinforcement member 3 is insert-molded in the peripheral wall 2a. As a result, the reinforcement member 3 is buried in the tubular member 2.

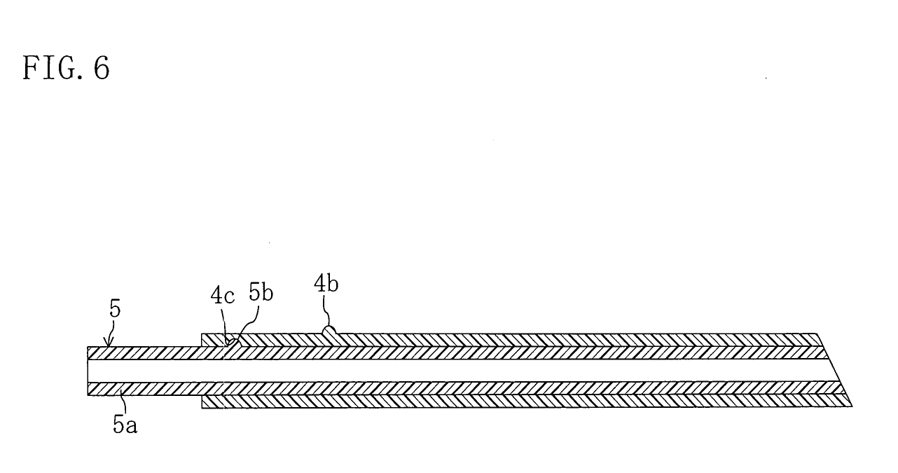

The first guiding member 4 has a tubular shape insertable into the inner passageway 2b as shown in FIG. 1. The second guiding member 5 has a tubular shape insertable into the first guiding member 4 as also shown in FIG. 6. The first guiding member 4 and the second guiding member 5 are made of a resin material harder than the resin material of the tubular member 2, for example, polyethylene. As shown in FIG. 6, the first guiding member 4 and the second guiding member 5 linearly extend. As shown in FIG. 1, the first guiding member 4 and the second guiding member 5 have such flexibility that, when inserted into the inner passageway 2b of the tubular member 2, the guiding members 4 and 5 are deformed in a curve conformable to the curved shape of the tubular member 2. The outside diameter of the first guiding member 4 is set slightly smaller than the inner passageway 2b, such that the first guiding member 4 can be readily inserted into the inner passageway 2b. The outside diameter of the second guiding member 5 is set slightly smaller than the inside diameter of the first guiding member 4, such that the second guiding member 5 can be readily inserted into the first guiding member 4. The outside diameter of the second guiding member 5 is set slightly larger than the inside diameter of the pharynx 100 of a person to which the supporting device 1 is to be applied.

The thickness of the peripheral walls 4a and 5a of the first guiding member 4 and the second guiding member 5 is set approximately equal to that of the peripheral wall 2a of the tubular member 2. The length of the first guiding member 4 in the center line direction is set larger than the length of the tubular member 2 in the center line direction. The length of the second guiding member 5 in the center line direction is set larger than the length of the first guiding member 4 in the center line direction. The oral cavity ends and digestive organ ends of the first guiding member 4 and the second guiding member 5 are formed in the same way as the oral cavity end and digestive organ end of the tubular member 2. The outer and inner surfaces of the first guiding member 4 and the second guiding member 5 may be coated as is the tubular member 2. The first guiding member 4 and the second guiding member 5 may be formed to have a curved shape as is the tubular member 2.

As shown in FIG. 1, the inner surface of the first guiding member 4 on the oral cavity side has a cavity 4c, while the outer surface of the second guiding member 5 on the oral cavity side has a protrusion 5b which is fittingly engageable with the cavity 4c. The protrusion 5b exists at such a position that, when the protrusion 5b is engaged with the cavity 4c, the digestive organ end of the first guiding member 4 is generally coincident with the digestive organ end of the second guiding member 5.

Thus, the tubular member 2, the first guiding member 4 and the second guiding member 5 are kept integrated by engaging the cavity 2c of the tubular member 2 with the protrusion 4b of the first guiding member 4 and engaging the cavity 4c of the first guiding member 4 with the protrusion 5b of the second guiding member 5. This prevents, when the supporting device 1 is carried about, the first guiding member 4 and the second guiding member 5 from falling out of the tubular member 2.

Although not shown, a protrusion may be provided on the inner surface of the tubular member 2 while a cavity engageable with the protrusion of the tubular member 2 may be provided on the outer surface of the first guiding member 4. Further, a protrusion may be provided on the inner surface of the first guiding member 4 while a cavity engageable with the protrusion of the first guiding member 4 may be provided on the outer surface of the second guiding member 5. The shape of the protrusions and cavities is not limited to those illustrated in the drawings.

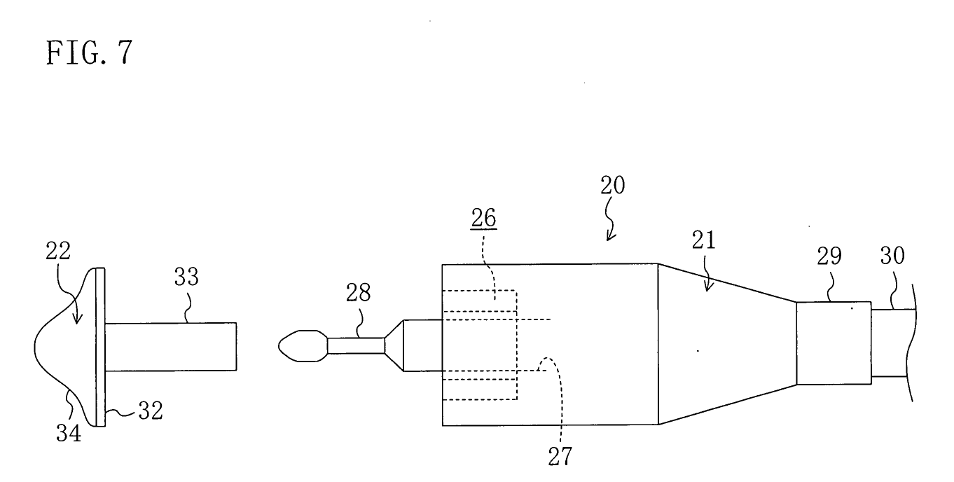

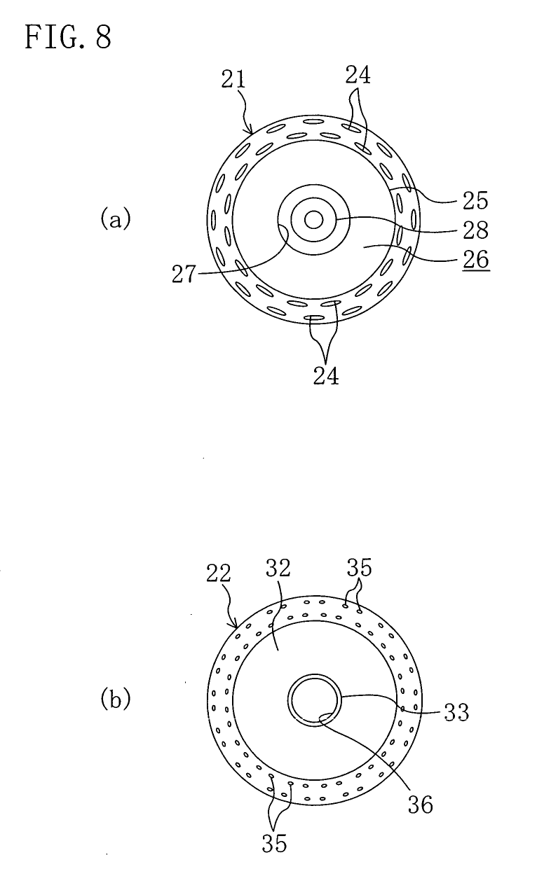

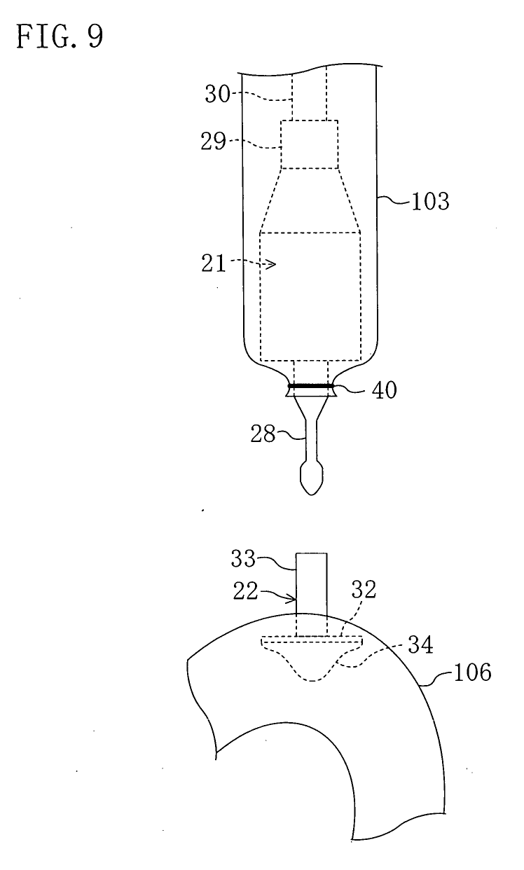

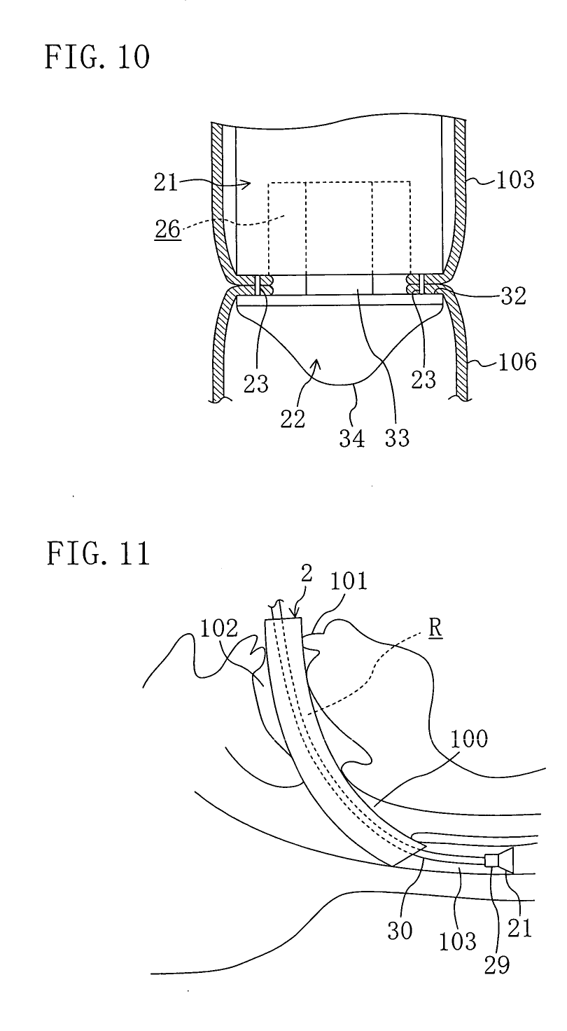

Next, total extirpation of a stomach affected by cancer (not shown) using the above-described supporting device 1 is described. In this operation, the medical instrument is, for example, an anastomosis device 20 as disclosed in Japanese Laid-Open Patent Publication No. 8-66406. Firstly, the structure of the anastomosis device 20 is described with reference to FIG. 7 to FIG. 10. The anastomosis device 20 includes a main body 21 and a head 22 detachable from the main body 21. The main body 21 has a generally cylindrical shape, and the outside diameter thereof is about 25 mm. As shown in FIG. 8(a), the outer periphery of an end face (“primary end face”) of the main body 21 is provided with a large number of slits 24 all around, through which metal staples 23 (shown only in FIG. 10) are thrust out. On the primary end face of the main body 21, the area inside the circle of slits 24 is provided with an annular cutter 25 (shown only in FIG. 8). The blade edge of the cutter 25 is approximately coplanar with the primary end face of the main body 21.

On the primary end face of the main body 21, the area inside the cutter 25 is provided with a cavity 26 for stowing pieces of organic tissue (described later) cut off by the cutter 25. The bottom of the cavity 26 extends generally perpendicular to the center line of the main body 21 as shown in FIG. 7. The central area of the bottom of the cavity 26 is provided with a hole 27 extending in the center line direction of the main body 21. An engagement bar 28 is inserted and retained in the hole 27. The engagement bar 28 is made of, for example, a metal material, such as stainless steel, or the like, and is provided so as to extend straight in the center line direction of the main body 21. The engagement bar 28 has a pointed tip.

The inside of the main body 21 includes an actuator (not shown) for reciprocating the engagement bar 28 in the center line direction. This actuator has a well-known structure which operates on the supply of electric power. The other end of the main body 21 is provided with a connector 29. The connector 29 accepts an end of a cord 30 for supplying electric power to the actuator. The anastomosis device 20 has a controller (not shown) for supplying electric power to the actuator. The other end of the cord 30 is connected to the controller. When this controller supplies electric power to the actuator to withdraw the engagement bar 28, the engagement bar 28 is pulled back and accommodated in the main body 21. If in this situation the actuator is activated to thrust forward the engagement bar 28, the engagement bar 28 extends out of the cavity 26.

The inside of the main body 21 is capable of accommodating a large number of staples 23 correspondingly to the slits 24. Each staple 23 has a generally U-shape and provided such that the opened part of the shape of “U” faces outward through the slit 24. Further accommodated in the inside of the main body 21 is a stapler mechanism (not shown) for thrusting out the staples 23 as actuated by the actuator. This stapler mechanism is also a well known mechanism.

The head 22 has a generally umbrella-shape. The head 22 includes a disk member 32 conformable to the shape of the primary end face of the main body 21, an extended part 33 extending from the center of the disk member 32 in the center line direction, and a mound member 34 elevated on the other side of the disk member 32 with respect to the extended part 33.

The disk member 32 is made of, for example, a metal material, such as stainless steel, or the like. The disk member 32 has a large number of hollows 35 on its surface facing the main body 21 along the outer perimeter correspondingly to the slits 24 as shown in FIG. 8(b). These hollows 35 compressively bend an open end of a staple 23 pushed out through the slit 24. The blade edge of the cutter 25 of the main body 21 abuts on the disk member 32 at an inner position with respect to the circle of hollows 35.

The extended part 33 is formed of the same metal material as that of the disk member 32 in a cylindrical shape. The extended part 33 has an engagement hole 36 on the other side of the disk member 32. The engagement bar 28 is inserted into the engagement hole 36 for engagement. Specifically, the extended part 33 has an engagement mechanism (not shown) for engaging with longitudinal intermediate part of the inserted engagement bar 28 to prevent the engagement bar 28 from falling out of the engagement hole 36. The mound member 34 is made of a resin material and is fixed to the disk member 32.

Next, the procedure of inserting the tubular member 2 of the supporting device 1 into the pharynx 100 is described. This tubular member 2 is inserted after the second guiding member 5 and the first guiding member 4 are inserted into the pharynx 100 of a patient lying face up. Specifically, at the first step, the mouth of the patient is opened and, although not shown, the second guiding member 5 is inserted into the oral cavity 102 with its digestive organ end first and thrust into the pharynx 100 as it is. In this process, tapered part of the second guiding member 5 faces the back side of the patient. The second guiding member 5 is thrust till its digestive organ end reaches the vicinity of the entrance of the esophagus 103. When the second guiding member 5 is entirely inserted, the pharynx 100 is expanded by the second guiding member 5 so that its inside diameter is increased. The second guiding member 5 is long and has a small diameter as compared with the first guiding member 4 and the tubular member 2 and is therefore insertable into the pharynx 100 relatively readily.

In the process of inserting the second guiding member 5 into the pharynx 100, the second guiding member 5 can be smoothly inserted while pushing aside tissues blocking the pharynx 100 because the digestive organ end of the second guiding member 5 has a tapered shape.

Thereafter, the first guiding member 4 is inserted into the pharynx 100 with the digestive organ end first. In this case, firstly, the oral cavity end of the second guiding member 5 is inserted into the first guiding member 4, and the first guiding member 4 is moved toward the digestive organ along the second guiding member 5. At this step, the first guiding member 4 is guided by the second guiding member 5. The first guiding member 4 is inserted till the digestive organ end of the first guiding member 4 reaches the vicinity of the digestive organ end of the second guiding member 5.

As the first guiding member 4 is inserted into the pharynx 100, the cavity 4c of the first guiding member 4 engages with the protrusion 5b of the second guiding member 5, such that the first guiding member 4 becomes immovable with respect to the second guiding member 5. In this condition, the digestive organ end of the first guiding member 4 is at substantially the same position as the digestive organ end of the second guiding member 5. Thus, the operator can perceive whether or not the insertion position of the first guiding member 4 is correct with respect to the second guiding member 5 only by engaging the cavity 4c with the protrusion 5b.

When the first guiding member 4 is entirely inserted into the pharynx 100, the second guiding member 5 is covered with the first guiding member 4, and the pharynx 100 is expanded by the first guiding member 4 so that the inside diameter of the pharynx 100 is further increased.

When the first guiding member 4 is entirely inserted into the pharynx 100, the oral cavity end of the second guiding member 5 can extend ahead of the oral cavity end of the first guiding member 4 because the second guiding member 5 is longer than the first guiding member 4. With this arrangement, it is possible to readily hold the second guiding member 5 in fingers and pull out the second guiding member 5 from the oral cavity end of the first guiding member 4. Further, with the above-described coating on the inner surface of the first guiding member 4 and the outer surface of the second guiding member 5, it is possible to readily pull out the second guiding member 5.

Since the diameters of the first guiding member 4 and second guiding member 5 are smaller than the diameter of the tubular member 2, the work of inserting the first guiding member 4 and the second guiding member 5 into the pharynx 100 is simple as compared with insertion of the tubular member 2 into the pharynx 100. Since the first guiding member 4 and the second guiding member 5 are made of a resin material only, the first guiding member 4 and the second guiding member 5 do not cause load on the tissue of the oral cavity 102 and pharynx 100.

After the second guiding member is pulled out of the first guiding member, the tubular member 2 is inserted into the pharynx 100 with the digestive organ end of the tubular member 2 first. In this case, firstly, the oral cavity end of the first guiding member 4 is inserted into the inner passageway 2b of the tubular member 2, and then, the tubular member 2 is moved along the first guiding member 4 toward the digestive organ. In this process, the tubular member 2 is guided by the first guiding member 4. The tubular member 2 is inserted till its digestive organ end reaches the vicinity of the entrance of the esophagus 103.

In the process of inserting the tubular member 2 into the pharynx 100, the cavity 2c of the tubular member 2 engages with the protrusion 4b of the first guiding member 4, such that the tubular member 2 becomes immovable with respect to the first guiding member 4. In this condition, the digestive organ end of the tubular member 2 is at substantially the same position as the digestive organ end of the first guiding member 4. Thus, the operator can perceive whether or not the insertion position of the tubular member 2 is correct with respect to the first guiding member 4 only by engaging the cavity 2c with the protrusion 4b.

When the tubular member 2 is entirely inserted into the pharynx 100 as described above, the first guiding member 4 is covered with the tubular member 2, and the pharynx 100 is expanded by the tubular member 2 so that the inside diameter of the pharynx 100 is further increased. Thereafter, the first guiding member 4 is pulled out from the oral cavity end of the tubular member 2. The oral cavity end of the first guiding member 4 can extend ahead of the oral cavity end of the tubular member 2 because the first guiding member 4 is longer than the tubular member 2, and therefore, it is possible to readily hold the first guiding member 4 in fingers for pulling it out.

When the tubular member 2 is inserted into the pharynx 100, it is scarcely necessary to greatly deform the tubular member 2 and the reinforcement member 3 because the tubular member 2 has a curved shape conformable to the shape of the pharynx 100. Therefore, smaller force is sufficient for inserting the tubular member 2 and the reinforcement member 3 into the pharynx 100. Further, since it is not necessary to deform the tubular member 2 in such a way, the tubular member 2 is free from flattening deformation, so that the shape of the inner passageway 2b is maintained.

Since the pharynx 100 is expanded by the tubular member 2, force in flattening direction is imposed on the tubular member 2, but flattening deformation of the tubular member 2 is suppressed because the tubular member 2 is reinforced by the reinforcement member 3.

Since the reinforcement member 3 is formed by a thin plate extending along the perimeter of the inner passageway 2b, the dimension of the reinforcement member 3 in the thickness direction of the peripheral wall 2a, i.e., the thickness of the thin plate, T, is set smaller than the wire diameter when the conventional reinforcement member is formed by a wire, so that the thickness of the peripheral wall 2a is decreased, while the width of the thin plate, W, is set greater than the wire diameter of the conventional wire, whereby sufficient strength of the reinforcement member 3 can be obtained. Thus, flattening deformation of the tubular member 2 can be suppressed while the thickness of the peripheral wall 2a of the tubular member 2 is decreased. Therefore, the size of insertion space R of the medical instrument, which is formed by the inner passageway 2b of the tubular member 2, can be maintained to have a sufficient size for the main body 21, which has a larger diameter than that of a generally-employed endoscope, to pass through.

Since the inside diameter of the pharynx 100 is gradually increased by the second guiding member 5 and the first guiding member 4 whose diameters are smaller than that of the tubular member 2 before the tubular member 2 is inserted into the pharynx 100, the force necessary for inserting the tubular member 2 can be decreased. Since the tubular member 2 is inserted into the pharynx 100 after the pharynx 100 is gradually expanded in such a way, the load on a patient is decreased as compared with a case where the tubular member 2 is inserted into the pharynx 100 without such a pretreatment.

Meanwhile, the patient is laparotomized. A portion in the vicinity of the border between the esophagus 103 and the stomach and a portion in the vicinity of the border between the small intestine 106 and the stomach are cut, so that the stomach is enucleated.

Then, as shown in FIG. 11, the main body 21 of the anastomosis device 20 is inserted from the oral cavity end of the tubular member 2 into the inner passageway 2b. In this process, the cord 30 is pushed into the inner passageway 2b, whereby the main body 21 is guided by the inner passageway 2b to the esophagus 103 to reach an area in the vicinity of the open end of the esophagus 103. Then, the engagement bar 28 of the main body 21 is extended from the open end of the esophagus 103, and the open end of the esophagus 103 is lashed, and thereby retained, to the basal end of the engagement bar 28 with a thread.

The head 22 is inserted into the small intestine 106 from the open end of the small intestine 106. The extended part 33 of the head 22 is thrust out of the peripheral wall of the small intestine 106, and the engagement bar 28 is inserted into and engaged with the engagement hole 36 of the extended part 33. Thereafter, the controller supplies electric power to the main body 21, so that the engagement bar 28 is pulled into the main body 21 as shown in FIG. 10, and as a result, the head 22 is in the vicinity of the main body 21 such that the peripheral wall of the esophagus 103 comes in contact with the peripheral wall of the small intestine 106.

While the head 22 is in the vicinity of the main body 21, staples 23 are thrust out through the slits 24 of the main body 21. The staples 23 penetrate through the peripheral wall of the esophagus 103 and the peripheral wall of the small intestine 106 to reach the hollows 35 of the head 22 and are bent by the hollows 35, whereby the esophagus 103 is anastomosed to the small intestine 106. At this time of anastomosis, the cutter 25 of the main body 21 abuts on the disk member 32 of the head 22, and the tissue of the esophagus 103 and small intestine 106 inside the circle of the anastomosed parts of the peripheral wall of the esophagus 103 and the peripheral wall of the small intestine 106 is ablated and stowed in the cavity 26 of the main body 21. It should be noted that, although not shown, the open end of the small intestine 106 is separately closed using a suture, or the like.

After completion of the anastomosis of the esophagus 103 with the small intestine 106, the cord 30 extending out from the oral cavity end of the tubular member 2 is pulled, whereby the main body 21 and the head 22 can be pulled out of the esophagus 103 through the inner passageway 2b of the tubular member 2 while the main body 21 and the head 22 are kept integrated with each other. After the main body 21 and the head 22 are pulled out of the esophagus 103, the tubular member 2 is pulled out of the pharynx 100.

Thus, according to this embodiment, the tubular member 2 is retained in the pharynx 100, and the main body 21 is guided by the tubular member 2 up to the vicinity of the exit of the esophagus 103. With such arrangements, the main body 21 can be inserted into the esophagus 103 without incision in the neck or chest. Therefore, in the case where the anastomosis device 20 is used for total extirpation of the stomach, the number of incisions in a patient can be reduced.

Since the reinforcement member 3 is formed by a thin plate extending along the perimeter of the inner passageway 2b of the tubular member 2, the thickness of the peripheral wall 2a of the tubular member 2 can be reduced while flattening deformation of the tubular member 2 is suppressed, so that large insertion space R can be secured for the main body 21. Since the tubular member 2 and the reinforcement member 3 are curved so as to be conformable to the shape of the pharynx 100, the force necessary for inserting the tubular member 2 and the reinforcement member 3 into the pharynx 100 is small, and accordingly, the workability of insertion of the tubular member 2 into the pharynx 100 is improved, while the load on a patient can be decreased.

Since the tubular member 2 is inserted into the pharynx 100 after the pharynx 100 is gradually expanded by the first guiding member 4 and the second guiding member 5, large insertion space R can be secured for the main body 21 while the load on a patient is suppressed, and the workability of insertion of the tubular member 2 into the pharynx 100 is further improved.

Since the resin material of the first guiding member 4 and the second guiding member 5 is harder than the resin material of the tubular member 2, flattening deformation of the guiding members 4 and 5 dwelling in the pharynx 100 is reduced so that the pharynx 100 can be effectively expanded. Since the tubular member 2, which has a larger diameter than the first guiding member 4, is made of a resin material softer than the resin material of the guiding member 4, the load on a patient can be further reduced.

Since the reinforcement member 3 has a spiral shape, intermediate part of the tubular member 2 in the center line direction can be continuously reinforced, and the shape of the inner passageway 2b can be maintained in the initial shape between its ends along the center line.

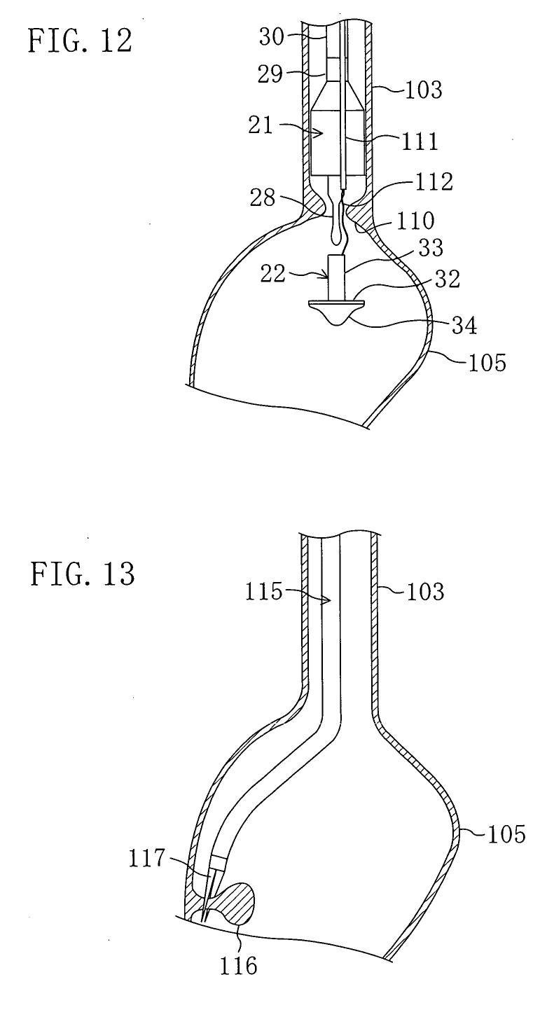

Referring to FIG. 12, the anastomosis device 20 can also be used for the treatment of a stricture 110 formed in the vicinity of the exit of the esophagus 103. The stricture 110 consists of a tumor swelling on the inner wall of the esophagus 103 toward the central area of the esophagus 103, or the like. In the treatment of the stricture 110, as in total extirpation of the stomach, the tubular member 2 is inserted into the pharynx 100, and the main body 21 is inserted up to the exit of the esophagus 103 through the tubular member 2. In this process, a tube 111, which is thinner than the cord 30 of the main body 21, is inserted up to the exit of the esophagus 103 through the tubular member 2 as is the main body 21. The tube 111 includes a thread passing therethrough from the oral cavity end of the tube 111, which is to be tied to the extended part 33 of the head 22.

After the laparotomy of the patient, the wall of the stomach 105 is incised, and the head 22 is inserted inside the stomach 105. Before the insertion of the head 22 into the stomach 105, an end of a thread 112 is tied to the extended part 33 of the head 22. After the head 22 is inserted into the stomach 105, the thread 112 is pulled from the oral cavity side, whereby the extended part 33 of the head 22 is oriented to the main body 21. With this orientation, the engagement bar 28 is inserted into and engaged with the engagement hole 36 of the extended part 33. Thereafter, the main body 21 is supplied with electric power by a controller, and the engagement bar 28 is pulled back into the main body 21, so that the head 22 is in the vicinity of the main body 21. As a result, the stricture 110 of the esophagus 103 is sandwiched by the disk member 32 of the head 22 and the cutter 25 and ablated by the cutter 25. The ablated part is stowed in the cavity 26 of the main body 21. Thereafter, the main body 21 and the head 22, which are still integrated together, are pulled out of the esophagus 103 through the inner passageway 2b of the tubular member 2.

In the case where two medical instruments, for example, the main body 21 and the tube 111, need to be inserted into the esophagus 103 as in the treatment of the stricture 110, using the supporting device 1 makes the manipulation easier and reduces the load on the patient.

Referring to FIG. 13, the supporting device 1 of the present invention can be used for removing a tumor 116 produced on the inner wall of the stomach 105 using an ablation instrument 115 insertable into a digestive organ. The ablation instrument 115 is one that has been conventionally used in medical workplaces. The ablation instrument 115 includes a scissors-like blade 117 at the tip, which is the leading end for insertion to a digestive organ, and a manipulator (not shown) at the basal end for manipulating the blade 117. In the case where the ablation instrument 115 is used to ablate the tumor 116, the ablation instrument 115 is inserted through the tubular member 2 to pass through the esophagus 103 and reach the stomach 105 in the same way as the main body 21 is in the extirpation of the stomach. The position of the tip end of the ablation instrument 115 can be adjusted by externally manipulating the basal end of the ablation instrument 115 outside the oral cavity 102. When adjusting the position of the ablation instrument 115, the ablation instrument 115 itself is moved. However, the ablation instrument 115 moves only in the tubular member 2 but does not scratch the inner wall of the pharynx 100. Therefore, the load on the patient can be reduced. After the tip of the ablation instrument 115 is positioned in the vicinity of the tumor 116, the blade 117 is manipulated by the manipulator to ablate the tumor 116. The ablated tumor 116 is held at the tip of the ablation instrument 115. The ablation instrument 115 holding the ablated tumor 116 is pulled out of the stomach 105.

In the operation of ablating the tumor 116 of the stomach 105, an endoscope (not shown) may be inserted into the stomach 105 in addition to the ablation instrument 115. In such a case where two medical instruments are inserted in the stomach 105, using the supporting device 1 makes the manipulation easier and reduces the load on the patient.

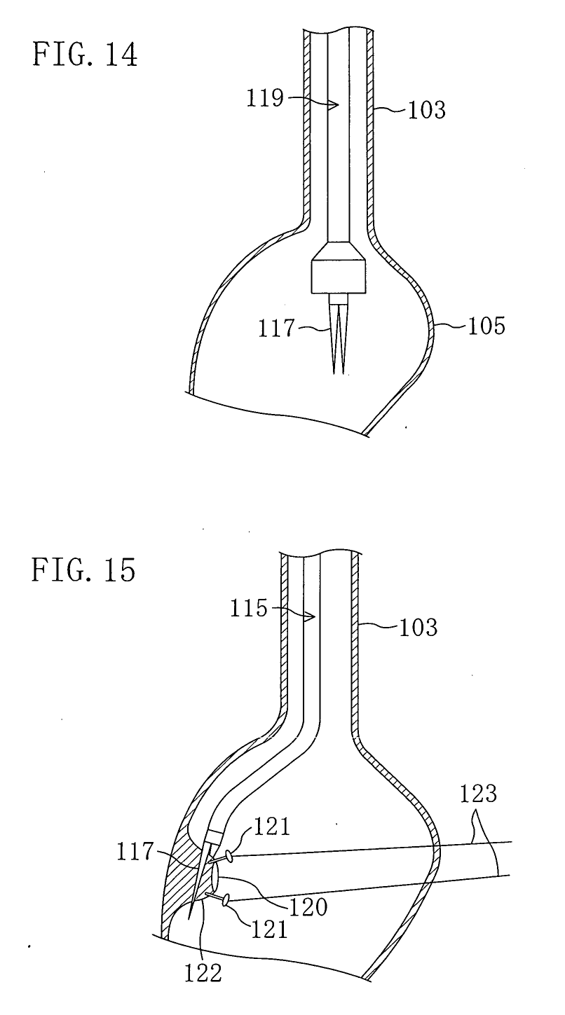

Referring to FIG. 14, a medical instrument having an endoscope 119 and a small blade 117 integrated therewith may be used to ablate the tumor 116 of the stomach 105 (shown in FIG. 13). The endoscope 119 is one that has been conventionally used in medical workplaces. An end portion of the endoscope 119, which is the leading end for insertion, has a larger diameter. In such a case where the endoscope 119 whose end portion has a larger diameter as compared with conventional endoscopes is inserted to the stomach 105, using the supporting device 1 makes the manipulation easier and reduces the load on the patient.

Referring to FIG. 15, the supporting device 1 of the present invention can also be used in the ablation of early-stage stomach cancer 120 produced on the gastric mucosa of the stomach 105 with the ablation instrument 115 insertable into a digestive organ. In the process of ablating the early-stage stomach cancer 120, a small incision is first made on the abdomen of a patient without laparotomy, and two pins 121 are inserted through this incision in the abdominal cavity using an insertion tool (not shown). These pins 121 pierce through the wall of the stomach 105 to be inserted inside the stomach 105 and stuck in the mucous membrane 122 in the vicinity of the cancer 120. The pins 121 are provided with threads 123 tied thereto, and the other ends of the threads 123 are out of the abdominal cavity through the incision on the abdomen. The ablation instrument 115 used herein is the same as the ablation instrument 115 used for ablating the tumor 116 of the stomach 105 and is inserted in the stomach 105 in the same way. By pulling the threads 123 to the outside of the abdominal cavity to pull the mucous membrane 122 in the vicinity of the cancer 120 toward the inside of the stomach 105, the mucous membrane 122 is deformed to the shape of a mound. The mound portion of the mucous membrane 122 is ablated by the blade 117 of the ablation instrument 115, whereby the early-stage stomach cancer 120 can be ablated.

In general, in the case of the early-stage stomach cancer, the cancer 120 is produced only in the mucous membrane 122 of the stomach 105, and it is not necessary to ablate the wall of the stomach 105. Only by, as described above, inserting the ablation instrument 115 into the stomach 105 and forming small openings in the wall of the stomach 105 for passage of the pins 121, the early-stage stomach cancer 120 can be ablated with less load.

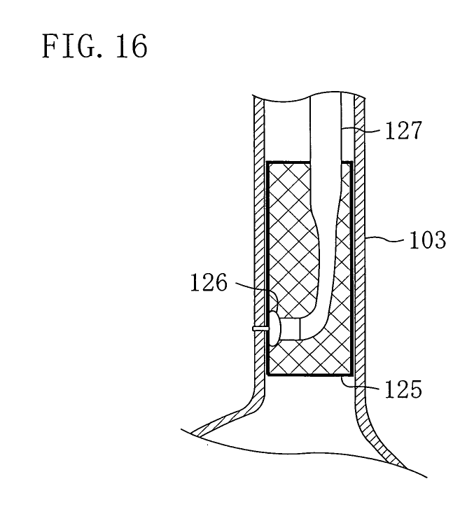

Referring to FIG. 16, the supporting device 1 of the present invention can be used for installing a stent 125 in the esophagus 103. The first step of the method for installing the stent 125 is to insert the stent 125 to a position in the esophagus 103 at which the stent 125 is to be installed. Thereafter, a pin 126 for affixing the stent 125 to the inner wall of the esophagus 103 and a stick 127 as the medical instrument for sticking the pin 126 in the esophagus 103 are inserted up to the esophagus 103 through the tubular member 2. Then, a centesis portion of the pin 126 is oriented from the inside of the stent 125 toward the inner wall of the esophagus 103, and thereafter, the head of the pin 126 is pushed toward the outside of the esophagus 103 such that the centesis portion of the pin 126 pierces through the stent 125 and is stuck in the esophagus 103. In this way, the stent 125 can be installed at a predetermined position in the esophagus 103.

In embodiment 1, the tubular member 2 and the reinforcement member 3 have curved shapes so as to be readily inserted into the pharynx 100. Therefore, the first guiding member 4 and the second guiding member 5 may be omitted.

### Embodiment 2

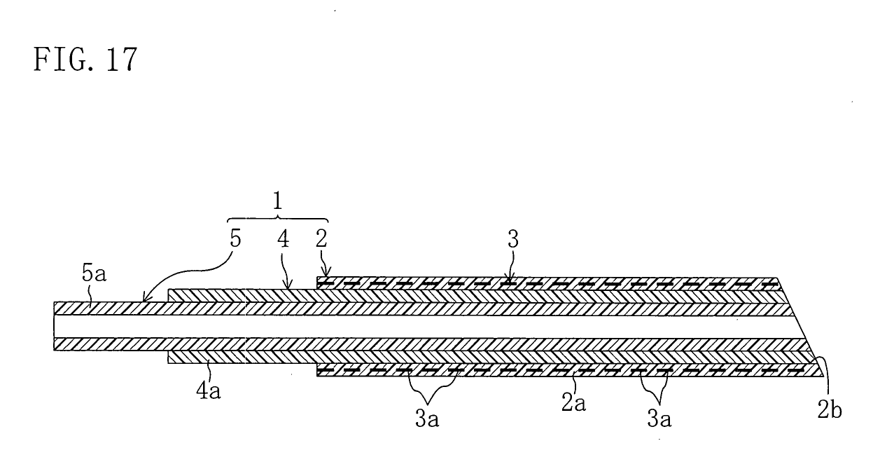

FIG. 17 is a cross-sectional view of a supporting device 1 according to embodiment 2 of the present invention for supporting insertion of a medical instrument into a human body. The supporting device 1 of embodiment 2 is different from, but otherwise the same as, the supporting device 1 in that the shape of the tubular member 2 is linear and that the supporting device 1 of embodiment 2 bears alignment marks. Hereinafter, the same parts as those of embodiment 1 are denoted by the same reference numerals, and the descriptions thereof are omitted, while only the differences are described.

In this embodiment, the tubular member 2 has a linearly elongated shape. Therefore, the reinforcement member 3 insert-molded in the peripheral wall 2a of the tubular member 2 has such a shape that the center line linearly extends.

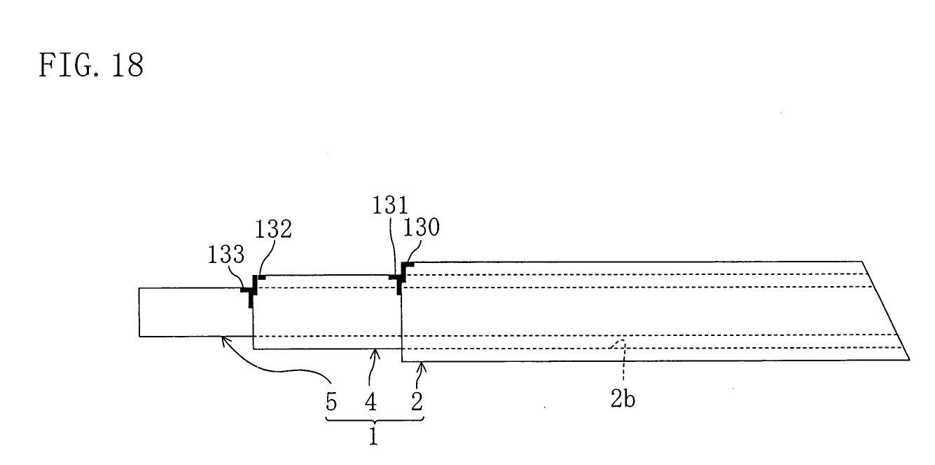

Referring to FIG. 18, the oral cavity end of the tubular member 2 is provided with a tubular member alignment mark 130. The tubular member alignment mark 130 is made by applying paint of a color different from that of the resin material of the tubular member 2 on the outer surface of the tubular member 2. The tubular member alignment mark 130 includes a part extending in the perimeter direction of the tubular member 2 and a part extending in the center line direction of the tubular member 2.

The oral cavity end of the first guiding member 4 is provided with two first guiding member alignment marks 131 and 132 provided in the center line direction of the guiding member 4 with an interval therebetween. The first guiding member alignment marks 131 and 132 are made by applying paint of a color different from that of the resin material of the first guiding member 4 on the outer surface of the first guiding member 4.

The first guiding member alignment marks 131 and 132 each has a part extending in the perimeter direction of the first guiding member 4 and a part extending in the center line direction of the first guiding member 4. Among the first guiding member alignment marks 131 and 132, the alignment mark 131 which is on the digestive organ side is positioned such that, when aligned with the tubular member alignment mark 130, the digestive organ end of the first guiding member 4 is generally coincident with the digestive organ end of the tubular member 2. Since the tubular member alignment mark 130 and the first guiding member alignment mark 131 are made on only parts of the perimeter, a predetermined position on the tubular member 2 in the perimeter direction can be made generally coincident with a predetermined position on the first guiding member 4 in the perimeter direction. Thus, tapered part of the digestive organ end of the tubular member 2 can be made generally coincident with tapered part of the digestive organ end of the first guiding member 4.

The oral cavity end of the second guiding member 5 is provided with a second guiding member alignment mark 133. The second guiding member alignment mark 133 is made by applying paint of a color different from that of the resin material of the second guiding member 5 on the outer surface of the second guiding member 5. The second guiding member alignment mark 133 includes a part extending in the perimeter direction of the second guiding member 5 and a part extending in the center line direction of the second guiding member 5. The second guiding member alignment mark 133 is positioned such that, when aligned with the first guiding member alignment mark 132 which is provided at the oral cavity end of the first guiding member 4, the digestive organ end of the second guiding member 5 is coincident with the digestive organ end of the first guiding member 4. The alignment marks 130 to 133 may be formed by a cavity or projection as an alternative to the paint.

The supporting device 1 of embodiment 2 can be used, as can the supporting device 1 of embodiment 1, for total extirpation of a stomach, the treatment of a stricture of the esophagus, ablation of a tumor produced in the inner wall of the stomach, ablation of early-stage stomach cancer, installation of a stent, etc.

Specifically, when the supporting device 1 is used, the inside diameter of the pharynx 100 is gradually increased by the second guiding member 5 and the first guiding member 4 whose diameters are smaller than that of the tubular member 2 before the tubular member 2 is inserted into the pharynx 100. Therefore, the force necessary for inserting the tubular member 2 having a large diameter, which secures a large insertion space R for the medical instrument, into the pharynx 100 can be decreased. Further, the gradual expansion of the pharynx 100 can decreases the load on a patient.

The first guiding member 4 and the second guiding member 5 have smaller diameters than that of the tubular member 2 and are therefore readily insertable into the pharynx 100. The first guiding member 4 can guide the tubular member 2 into the pharynx 100 and make insertion of the tubular member 2 easier.

The second guiding member 5 has a smaller diameter and therefore can be readily and correctly inserted to a predetermined position in the pharynx 100. When inserting the first guiding member 4 into the pharynx 100 along the second guiding member 5, the digestive organ end of the first guiding member 4 is made coincident with the digestive organ end of the second guiding member 5 by aligning the first guiding member alignment mark 132 with the second guiding member alignment mark 133. With this, the operator can perceive whether or not the insertion position of the first guiding member 4 is correct with respect to the second guiding member 5 as a reference only by visually checking the alignment marks 132 and 133.

When inserting the tubular member 2 into the pharynx 100 along the first guiding member 4 in the same way, the digestive organ end of the tubular member 2 can be made generally coincident with the digestive organ end of the first guiding member 4 by aligning the tubular member alignment mark 130 with the first guiding member alignment mark 131. With this, the operator can perceive whether or not the insertion position of the tubular member 2 is correct with respect to the first guiding member 4 as a reference only by visually checking the alignment marks 130 and 131. It should be noted that the positions of the alignment marks 130 to 133 can be set arbitrarily. The position of the first guiding member 4 with respect to the second guiding member 5 and the position of the tubular member 2 with respect to the first guiding member 4 can be set according to the positions of the alignment marks 130 to 133.

Although in embodiments 1 and 2 the reinforcement member 3 is insert-molded in the tubular member 2, the reinforcement member 3 may be combined with a premolded tubular member 2.

The supporting device 1 can also be used for inserting a medical instrument other than those described above, such as a catheter, etc., into a digestive organ.

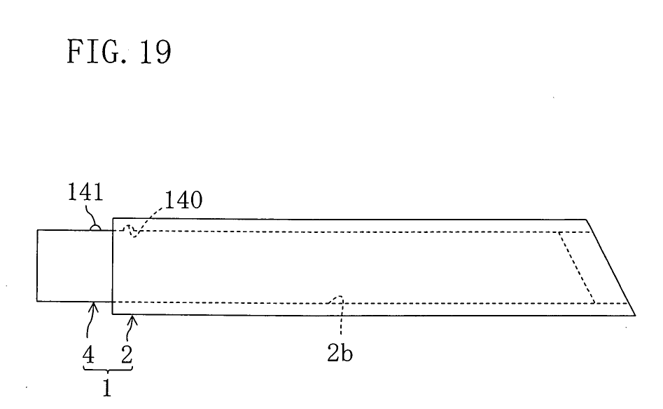

Although in embodiments 1 and 2 the pharynx 100 is gradually expanded by the first guiding member 4 and the second guiding member 5 before the tubular member 2 is inserted into the pharynx 100, the pharynx 100 may be expanded only by the first guiding member 4 before the tubular member 2 is inserted into the pharynx 100 as in the variation shown in FIG. 19.

In this variation, the inner surface of the tubular member 2 on the oral cavity side has a cavity 140, and the outer surface of the first guiding member 4 on the oral cavity side has a protrusion 141 fittingly engageable with the cavity 140. The protrusion 141 is positioned such that, when the protrusion 141 is engaged with the cavity 140, the digestive organ end of the first guiding member 4 is generally coincident with the digestive organ end of the tubular member 2. Thus, when inserting the tubular member 2 into the pharynx 100 along the first guiding member 4, the cavity 140 is engaged with the protrusion 141 so that the tubular member 2 becomes immovable with respect to the first guiding member 4. In this condition, the digestive organ end of the tubular member 2 can be made generally coincident with the digestive organ end of the first guiding member 4. With this, the operator can perceive whether or not the insertion position of the tubular member 2 is correct with respect to the first guiding member 4 as a reference only by engaging the cavity 140 with the protrusion 141. The cavity 140 is a tubular member engagement section of the present invention. The protrusion 141 is a guiding member engagement section of the present invention.

Although not shown, the tubular member engagement section may be formed by a protrusion, and the guiding member engagement section may be formed by a cavity. Alternatively, these engagement sections may have shapes different from the cavity and protrusion. The positions of these engagement sections can be set arbitrarily. The position of the tubular member 2 with respect to the first guiding member 4 can be set according to the positions of these engagement sections.

In the supporting device 1 of embodiment 1, the tubular member 2, the first guiding member 4 and the second guiding member 5 may be provided with alignment marks and engagement sections as in embodiment 2.

### INDUSTRIAL APPLICABILITY

As described above, a supporting device of the present invention for supporting insertion of a medical instrument into a human body is suitable to insertion of, for example, an anastomosis device for anastomosing digestive organs from the oral cavity into a digestive organ.

1. A supporting device for supporting insertion of a medical instrument into a human body, comprising:
a tubular member having an inner passageway between its opposite ends through which the medical instrument is capable of passing; and
a reinforcement member formed by a thin plate extending along a perimeter of the inner passageway,
wherein the tubular member and the reinforcement element have curved shapes conformable to the shape of a pharynx of a human body and, when inserted from an oral cavity into the pharynx and retained there, guide the medical instrument to a digestive organ through the inner passageway.

2. A supporting device for supporting insertion of a medical instrument into a human body, comprising:
a tubular member having an inner passageway between its opposite ends through which the medical instrument is capable of passing;
a reinforcement member extending along a perimeter of the inner passageway; and
a guiding member having a diameter smaller than the inner passageway and insertable from an oral cavity of a human body into a pharynx, the guiding member guiding, when inserted into the pharynx, the tubular member and the reinforcement member from the oral cavity to the pharynx,
wherein, when guided to the pharynx and retained there, the tubular member and the reinforcement member guide the medical instrument to a digestive organ through the inner passageway.

3. The supporting device of claim 1, further comprising a guiding member having a diameter smaller than the inner passageway of the tubular member and insertable from the oral cavity into the pharynx wherein, when inserted into the pharynx, the guiding member guides the tubular member and the reinforcement member from the oral cavity to the pharynx.

4. The supporting device of claim 1, wherein the reinforcement member has the shape of a spiral continuously extending in a center line direction of the inner passageway.

5. The supporting device of claim 1, wherein a digestive organ end of the tubular member extends toward a digestive organ ahead of a digestive organ end of the reinforcement member.

6. The supporting device of claim 1, wherein the digestive organ end of the tubular member is slanted with respect to the center line of the inner passageway.

7. The supporting device of claim 1, wherein the tubular member is molded with the reinforcement member buried therein.

8. The supporting device of claim 2, wherein:
the guiding member includes a guiding member engagement section; and
the tubular member includes a tubular member engagement section for engaging with the guiding member engagement section of the guiding member inserted up to a predetermined position in the inner passageway of the tubular member.

9. The supporting device of claim 2, wherein:
the guiding member has a guiding member alignment mark; and
the tubular member has a tubular member alignment mark aligned with the guiding member alignment mark of the guiding member inserted to a predetermined position in the inner passageway of the tubular member.

10. The supporting device of claim 1, wherein:
the tubular member is made of a resin material; and
the guiding member is made of another resin material harder than the resin material of the tubular member.
